(19) United States
(12) Patent Application Publication
(10) Pub. No.: US 2007/0041266 A1
(43) Pub. Date: Feb. 22, 2007

(54) Cavitation mixer or stabilizer

(76) Inventor: Elmar Huymann, Innsbruck (AT)

Correspondence Address: HEAD, JOHNSON & KACHIGIAN, 228 W 17TH PLACE, TULSA, OK, 74119, US

(21) Appl. No.: 11/499,453

(22) Filed: Aug. 4, 2006

(30) Foreign Application Priority Data
Aug. 5, 2005 (DE) 10 2005 037 026.8

(51) Int. Cl. B01F 3/08; B01F 5/04

(52) U.S. Cl. 366/162.4; 366/174.1

(57) ABSTRACT

A device for mixing the components of a mass flow flowing through the same provides a particularly homogenous mixture which remains stable for any length of time, even when the components concerned are generally not miscible or are very difficult to mix. The device has a body (8) which is located in a throughflow chamber (4) and is difficult to flow around. This body is situated at least partially in a part of the throughflow chamber (4) that expands in the direction of the flow, so that the cavitation effect and the mixing effect of the supercavitation field produced by the body (8) that is hard to flow around are considerably amplified.

### CROSS-RELATED APPLICATIONS

This application claims priority from, and incorporates by reference, German patent application serial No. 10 2005 037 026.8, filed Aug. 5, 2005.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates generally to a hydrodynamic cavitation mixer or stabilizer.

As it is generally known these mixers are used to produce a suspension or emulsion with minor effort and without mechanically driven parts through initially creating vapor filled gas bubbles in a moving fluid, which subsequently collapse again in an implosion.

When this implosion of a large number of bubbles, so called cavitation bubbles, occurs close to the boundary surface between two phase areas, e.g. large oil droplets in water, thereby the second component, in this case the oil droplets, is torn into small units. Hereby a very fine mixing of the two components and a very stable suspension or emulsion is created.

The cavitation bubbles are created in the moving fluid through a drop in static pressure below the vapor pressure of the fluid, whereby vapor filled gas bubbles are created, e.g. due to a flow contraction.

When the static pressure increases again subsequently due to an expansion of the flow cross section and the static pressure increases above the vapor pressure again, the gas bubbles collapse.

The static pressure of water becomes zero or negative, when the flow velocity increases above a certain value, depending on environmental conditions, e.g. at the separation edges this value is approximately 14 m/sec.

The contraction and the subsequent expansion of the flow cross section can be accomplished through placing an obstacle body into the flow chamber, whereby the resulting gap, e.g. between the obstacle body and the surrounding housing of the flow chamber, forms the bottleneck.

Through the multiple arrangement of such obstacle bodies behind each other, due to space constraints preferably in the form of discs positioned perpendicular to the direction of the flow, the cavitation effect is multiplied, in particular, when the area of the annular gap gets smaller from one disc to another in flow direction.

In addition to the first cavitation field formed in the annular gap, additional cavitation fields are created in the flowed through flow cavities between the obstacle bodies, and through the spatial overlay of the single cavitation fields a so called super cavitation field is created, which induces a multiplication of the cavitation effect of each single cavitation field.

2. Description of Related Art

Hereby it is state of the art to reduce the annular gap area in flow direction through:
a sequence of discs as obstacle bodies, increasing in size in flow direction and forming a cut off cone in their entirety, located in a surrounding cylindrical housing as a flow chamber, e.g. according to DE 44 33 744, or
in another conical housing as a flow chamber, but with less taper than the taper of the cone or cut off cone formed through the obstacles, however still providing a reduction of the area of the annular gap in flow direction, e.g. according to EP 1 280 598, creating a so called hydrodynamic super-cavitation field.

### BRIEF SUMMARY OF THE INVENTION

It is an objective according to the invention to provide a mixer or stabilizer for an existing mixture, which is very simple and low in cost and which in particular also allows the supply of components in reverse flow.

Another aspect of the present invention is to provide a mixer for mixing or stabilizer for stabilizing at least two through flowing components, at least one component of the at least two through flowing components being liquid, through a hydrodynamic cavitation field including a housing, an intake opening which supplies at least one of the at least two through flowing components, an outlet opening for exhausting a mixture, a flow-through chamber between the intake opening and the outlet opening, a plurality of plate shaped obstacle bodies which lie in a plane perpendicular to a main flow direction and which are located in the flow-through chamber, and a plurality of flow-through gaps between edges of the plurality of plate shaped obstacle bodies and the housing. The plurality of plate shaped obstacle bodies have sharp separation edges, and the plurality of flow-through gaps have surface areas that decrease in the main flow direction as measured perpendicular to the main flow direction. A conical contraction section is located after the intake opening and is subsequently followed in the main flow direction by a conical expansion section in front of the plurality of plate shaped obstacle bodies. A first obstacle body of the plurality of plate shaped obstacle bodies is an impact plate. The mixer or stabilizer may further include at least a second intake opening for a second component of the at least two through flowing components, the second component of the at least two through flowing components being added in reverse flow to the main flow direction.

Another aspect of the present invention is to provide a method for mixing or stabilizing at least two through flowing components, at least one component of the at least two through flowing components being liquid, through a hydrodynamic cavitation field including providing a housing including an intake opening and an outlet opening, supplying at least one of the at least two through flowing components through the intake opening, providing a flow-through chamber between the intake opening and the outlet opening, providing a plurality of plate shaped obstacle bodies which lie in a plane perpendicular to a main flow direction and are located in the flow-through chamber, the plurality of plate shaped obstacle bodies having sharp separation edges and a first obstacle body of the plurality of plate shaped obstacle bodies being an impact plate, providing a plurality of flow-through gaps between edges of the plurality of plate shaped obstacle bodies and the housing, the plurality of flow-through gaps having surface areas that decrease in the main flow direction as measured perpendicular to the main flow direction, contracting the at least two through flowing components with a conical contraction section located after the intake opening and then subsequently expanding the at least two through flowing components with a conical expansion section in front of the plurality of plate shaped obstacle bodies, and exhausting a mixture through the outlet opening. The method may further include supplying in reverse flow to the main flow direction a second component of the at least two through flowing components through at least a second intake opening.

### BRIEF DESCRIPTION OF THE DRAWINGS

The invention will be described in detail with reference to the following drawings in which like reference numerals refer to like elements wherein:

FIG. 1 illustrates an exemplary mixer as a separate piece;

FIG. 2 illustrates an exemplary embodiment of the complete mixing device, this means the mixer installed into conduit;

FIG. 3 illustrates a longitudinal cut view through a part of the mixer;

FIG. 4 illustrates a cross sectional view of a part of the mixer; and

FIG. 5 illustrates a cross sectional view of another embodiment of the mixer.

### DETAILED DESCRIPTION OF THE INVENTION

Through providing the first obstacle body as an impact plate, this means with an impact surface providing as strong an obstacle as possible in the flow direction of the first component, which is planar or even concave towards the flow of the first component, the second component can be supplied through the obstacle body in reverse flow, so the two components mix thoroughly in the area directly in front of the impact surface, solely through the impact of the first component onto the impact plate.

Instead of producing a mixture, an already existing mixture can be processed with a similar device for the purpose of stabilization, wherein the mixture to be stabilized is then supplied instead of the first component, and no further component is added, thus no intake for the second component and no conduit for supplying it are needed.

The impact and the mixing are very strongly mixing, because beyond the first obstacle body there is no mounting fixture protruding into and against the flow of the first component, since this first, as well as subsequent obstacle bodies can be held in the center of the flow chamber by a holder, advantageously formed as a central axis, protruding against the flow of the first component.

Since the first component first passes through a contraction in flow direction after the intake and then through an expansion, both of them advantageously conical, a vacuum is created through the first component in the flow chamber in front of the impact plate, sucking the supplied second component into the flow chamber and additionally improving mixing.

A flow gap with an area decreasing in the direction of the main flow, this means in the direction of the flow of the first component alone, as well as of the mixture after the addition of the second component, can be accomplished in particular in combination with the impact of the first component onto the first obstacle body through obstacle bodies with decreasing cross sections in the direction of the main flow and thereby decreasing length of the annular gap around the obstacle bodies and thereby forming a narrowing cone in the flow direction.

Thereby the wall of the surrounding housing can extend in parallel to the cone of the obstacle bodies or it can form a more pronounced cone (larger angle at the tip of the cone), which increases the effect of the reduced annular surface even more. Also a less pronounced conical shape (smaller angle) at the tip of the cone is possible, which reduces the effect caused by the conical shape of the obstacle bodies to a certain extent.

The concave impact surface provides—especially in case of a more or less centric impact of the first component onto the impact surface and also with centric supply of the second component—a torus shaped turbulation of the mixture and another approach of the mixture towards the impact surface, from which it has been reflected, where it is mixed again additionally by the first component impacting again.

This effect can even be improved through supplying the second component on the impact area of the first obstacle body not in the center, but through orifices distributed around the center of the impact surface in an annular manner, whereas the impact of the first component remains central.

The central axis for fixating the obstacle bodies can be hollow and serve at the same time as a conduit for supplying the second component onto the impact surface.

The effect of the cross section expansion and the turbulence improves when there is a housing section with constant cross section between the cross section expansion and the impact plate, to let the pressure distribution over the cross section in the first component stabilize along this section.

The mixture produced is run off through an outlet opening, which exits the housing preferably in a radial manner, preferably in the form of a radial annular slot.

The efficiency of the device, which is normally inserted into an existing conduit, can be improved by—e.g. depending on the flow velocity in the supply conduit, the viscosity of the particular components and their mixability—axial adjustment of the obstacle bodies, with respect to the distance amongst each other, and/or in groups or in their entirety relative to the surrounding housing, whereby the absolute size of the annular gap surfaces is also changed in a cone shaped housing.

Furthermore it is advantageous to provide the obstacle bodies as plates in order to simplify manufacture and to reduce cost, whereby the plates are thin enough in particular, so their free edges can oscillate in the flow direction, which facilitates the generation and the breaking loose of vapor bubbles.

This generation is also facilitated through providing the obstacle bodies, e.g. the plates, with separation edges as sharp as possible.

The flow gap between the obstacle bodies and the housing can, e.g. when the obstacle bodies are round, thus discs, be the radial gap between the free outside circumferential edge of the discs and the surrounding housing.

However, there are also other embodiments possible, for example wherein the obstacle bodies, which are shaped like plates by all means reach the housing with their most outward radial point and are connected to it, but not along the entirety of their circumference, but only in segments, wherein radial slots or gaps are in the segments in between, which can be offset relative to each other in a radial direction from one obstacle body to the next, serving as flow-through gaps.

The formation of vapor bubbles and thereby the occurrence of cavitation is facilitated by separation edges, which are as long as possible.

For this purpose, in particular in the case of disc shaped obstacle bodies, whereby the perimeter constitutes the separation edge, the length of the separation edges can be increased through undulation or serration, wherein the non-linear contour can be seen in axial direction, or perpendicular to it, or in both directions.

In case the non-linear, this means undulated or serrated shape is visible when looking in axial direction, the surrounding housing, seen in axial direction, can also be shaped accordingly, whereby a constant cross section between the housing and the separation edge can be maintained along the whole circumference, or the housing has a continuously round inside contour, wherein the distances to the separation edge vary along the circumference.

When device is provided in a manner that certain flow characteristics are maintained during its operation, the cavitation effect is pronounced in particular.

The contraction of the cross section after the inlet should be sized in a way that the velocity of the flow in the tightest section of the contraction equals the flow velocity in the flow-through gap of the last obstacle body. On the other hand the flow velocity at the outlet after the last obstacle body should be slightly higher than in the flow-through gap at the last obstacle body.

A particularly simple embodiment is provided when round discs with a constant diameter in flow direction are being used, and a reduction of the annular gap is accomplished through a contraction of the housing in the direction of the main flow. This effect however is less pronounced than with conical obstacle bodies of decreasing size, discs in particular.

A strong contraction after the inlet is advantageous in particular, wherein the flow velocity from the inlet to the bottleneck of the contraction increases by a factor of 9-13, in particular by a factor of 10-12, in particular by a factor of 10.5 to 11.5.

Furthermore, it is advantageous to size and to position the obstacle bodies relative to each other and/or relative to the surrounding housing in a manner that the flow velocity in the flow-through gap at the last obstacle body in flow direction, compared to the flow-through gap of the first obstacle body, is increased by a factor of 1.8-2.5, in particular by 2.0-2.3.

The same applies, when it is accomplished that the flow velocity from one obstacle body to the next in the respective flow-through gap increases by a factor of 1.1 to 1.4.

As an optimum tradeoff between a simple design and high efficiency of the device, a number of obstacle bodies between 3 and 10, and especially between 5 and 7, has become apparent.

When, in the case of metal discs especially made from stainless steel, the thickness is between 1 mm and 4 mm, in particular between 2 mm and 4 mm, their manufacture is very simple, in particular a cutting edge perpendicular to the major plane of the plates can be used, and the plates on the other hand are sufficiently elastic.

The axial distance between the middles of two adjacent obstacle bodies should be two to seven times the thickness of the plates, in particular three to five times.

The radial width of the annular gap between the outer perimeter of the plate shaped obstacle bodies and the housing should be between 1 mm and 5 mm, in particular between 1.5 mm and 3.8 mm.

Furthermore an axial length of the section of the housing with constant cross section between the cross section expansion and the impact plate of 0.7 to 1.4 times the diameter after the cross section expansion has proven to be advantageous.

Likewise, the interior free diameter after the cross section expansion, this means along the section with constant cross section, should be between 0.9 times to 2.0 times, in particular between 0.9 times and 1.1 times the diameter of the free cross section of the in feed and/or outlet conduit.

Advantageously, the first obstacle body, forming an impact plate and possibly the second impact body, will have a much larger extension in axial direction than the other more plate-shaped obstacle bodies. These first obstacle bodies, which are thicker in an axial direction, preferably have an annular, concave groove along their outer circumference, so they have two annular, axially offset separation edges, wherein the groove should be at least the size of the radial width of the annular gap, preferably a multiple of this gap.

The separation edges are efficient in particular, when they have an oblique angle of less than 60°, seen in cross section, preferably less than 50° or even 45°, whereby they are especially sharp.

Thereby preferably the first separation edge in main flow direction of the first obstacle body should be in the area of the housing with constant interior diameter, and only the second, as well as all following separation edges, should be in the axial area of the contracting interior diameter of the housing.

Overall, the device should be sized in a manner so that a pressure drop of 2.5 to 3 bars occurs over its total length.

For adjustability in longitudinal direction several obstacle bodies can be integrated into a group, wherein they are moveable in longitudinal direction along the central axis only together, in particular in the area of the last obstacle body, which reduces the effort it takes to manufacture the device, but reduces efficiency only to a moderate extent.

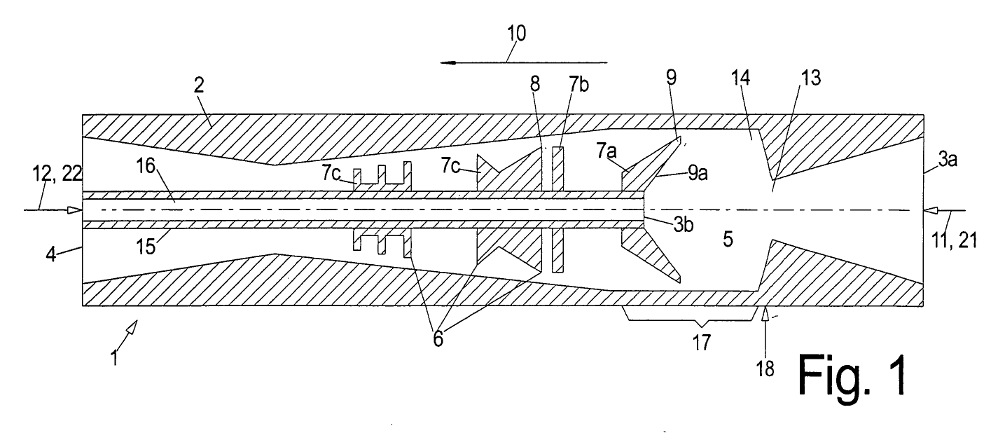

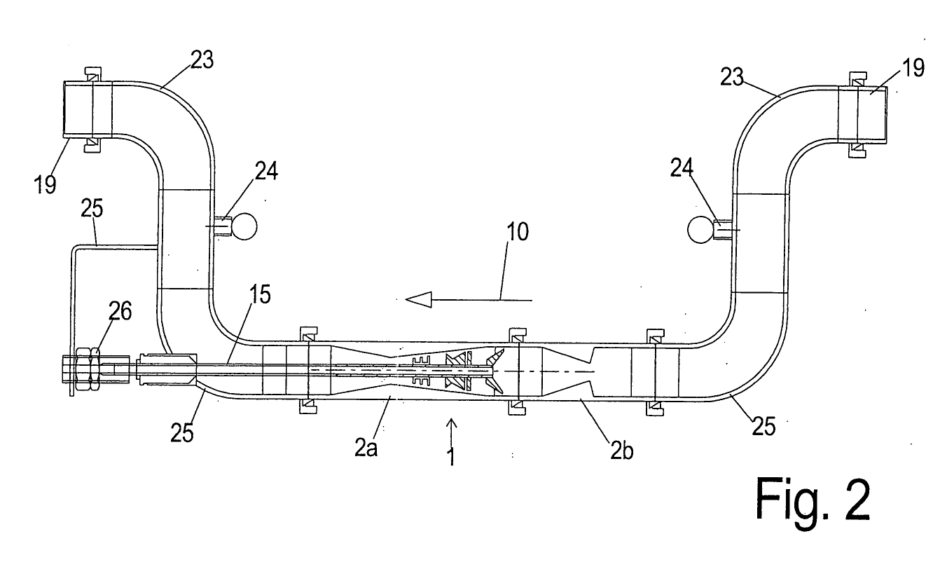

FIG. 1 shows the mixer itself, comprising a tubular housing (2), preferably rotationally symmetrical to the main flow direction (10), which is passed through by the first component (21) in FIGS. 1 and 2 in the main flow direction (10) from the right to the left.

Hereby, the left open face forms the intake opening (3a) for the first component which enters into the flow-through chamber (5), initially passing through a contraction (13) towards its bottleneck (18).

Thereafter comes a much more rapid, this means shorter expansion (14) to a free cross section approximately equivalent to the intake opening (3a) or slightly larger, however with an expansion distance of only ⅕ to 1/10 of length the contraction distance.

Thereafter comes a section (17) with a constant diameter of the flow-through chamber (5), followed by a longer section with a conical decrease of the free cross section, followed by an approximately equivalent expansion.

Cavitation occurs next to the obstacle bodies (7a,b,c) located in the flow-through chamber (5), the first of which is still located in the constant interior diameter section (17), the remaining ones are located thereafter in the main flow direction (10) in the area of the decreasing open diameter.

The obstacle bodies (7) are located on a central axis (15) protruding from the side of the outlet opening (4) in the center of the flow chamber (5) into it, ending with the first obstacle body (7a).

By providing the central axis (15) as a hollow conduit (16), it serves as a feed line for the second component (22), which is thereby provided in the flow direction (12), this means against the flow direction (11) of the first component, into the flow-through chamber (5), where it ends in the second intake opening (3b) in the front face of the first obstacle body (7a) pointing against the major flow direction (10).

This first obstacle body (7a) serves as an impact plate (9) for the first component with a frontal impact surface (9a), which is concave towards the flow direction (11) of this first component and wherein the second opening (3b) for the second component (22) is provided at its lowest spot.

The first obstacle body (7a) provided as an impact plate (9) has the largest cross section, whereas the following obstacle bodies (7b) and (7c) have a cross section that is decreasing in comparison, preferably in analogy to the decreasing open diameter inside the flow-through chamber (5), so the radial width of the annular flow gap (6) between the obstacle body and the surrounding housing (2) stays constant, or even decreases in the flow direction (10).

Some of the obstacle bodies (7a-d) shown as examples have several axially spaced, annular separation edges (8) protruding towards the housing (2) the farthest.

The third obstacle body (7c), when seen in a longitudinal cut view is provided with an annular groove on its outer circumference, which abuts to a separation edge (8) in the axial front and back in an axial direction and it has two planar, parallel surfaces facing the flow, exactly perpendicular to the direction of the axis.

The flanks of the annular grooves in the enveloping surfaces of these obstacle bodies transition into the enveloping surface in an acute angle, forming separation edges (8), whose angle at the front most separation edge, this means at the impact surface (9a) is approximately 45°, wherein both angles of the separation edges can also be under 45°.

The fourth obstacle body (7c) includes several, in this case three, axially spaced and firmly connected radial discs with constant thickness, whose narrow outer enveloping surfaces are parallel to the flow direction (10) and hereby perpendicular to the plane of the discs. The obstacle body (7b) is shown as a single disc, which will be the preferred form of obstacles.

The obstacle bodies (7a, b, c) are independently adjustable in an axial direction along the central axis (15), in addition the whole axis (15) is adjustable in axial direction, which can be seen best from FIG. 2, which shows the installation of the mixer (1) into an existing conduit (19).

From this conduit (19), through conduit elbows (23), an angulation and an offset relative to the track of the conduit (19) are created, including the cutoff valves (24) provided in the conduit to and from the mixer (1).

Through the two additional conduit elbows (23′), which transition again into the original, parallel offset track of the conduit (19), the mixer (1) can be mounted parallel to the track of the conduit (19) between the two conduit elbows (23′). This way the linear central axis (15), which can serve as a supply line (16) for the supply of the second component, can be run out through the exterior wall of the one conduit elbow (23′) and supported with a support (25) and adjusted with a counter nut (26) in axial direction.

FIG. 2 shows, that the free cross section at the intake opening (3a), as well as at the outlet opening (4) matches the free cross section of the remaining conduit (19) and, that the housing (2) of the mixer is made from two parts, wherein part (2a) is the housing section containing the obstacle bodies (7) and part (2b) is the one containing the contraction located in flow direction in front of the obstacle body and the subsequent cross section expansion.

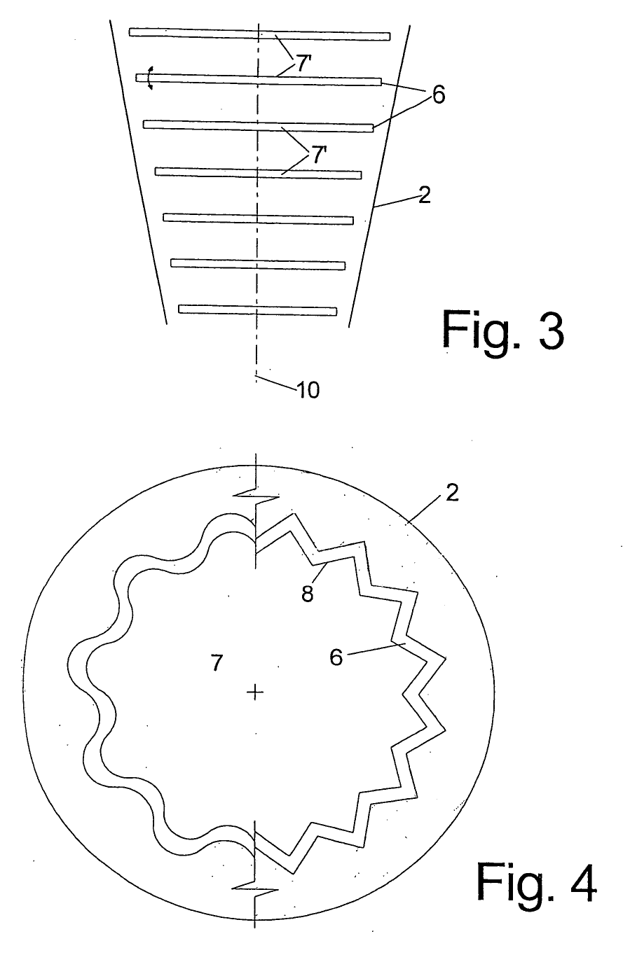

FIG. 3 shows a special embodiment of the obstacle body (7) including preferably single discs (7′) which are thin, at least along their outer circumference.

Their thickness is selected relative to the elasticity of their material, so they can oscillate flexibly at their outer edge in and against the flow direction (10), which accelerates the occurrence of the cavitation effect. For this purpose the discs (7′) are held in their centers, and if necessary the discs can be thinner in the area of their free circumferential edges than in the remainder.

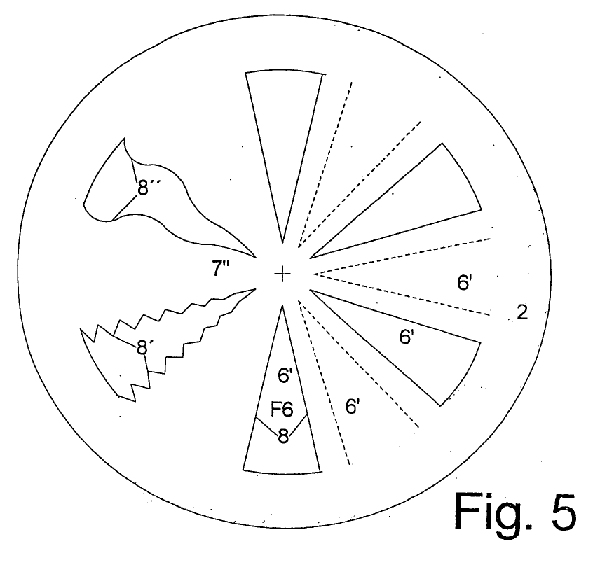

FIGS. 4 and 5 show embodiments for providing the flow gap (6).

In FIG. 4, analogous to FIG. 1 and FIG. 2, the flow gap (6) is an annular gap between the inner obstacle body (7) and the housing (2) surrounding the obstacle body (7) from the outside in a radial manner.

In order to extend the separation edge (8), this means the circumferential outer edge of the obstacle body (7) and thereby in order to improve the cavitation effect FIG. 4 shows how an extension in longitudinal direction can be accomplished through an undulated or serrated design of the separation edge (8). When the flow gap (6) shall be maintained at constant width along the circumference, also the inside contour of the housing (2) is shaped in an analogous manner.

FIG. 5, on the other hand, shows an embodiment where the flow-through gap (6′) is not a circumferential annular gap between the obstacle body (7″) and the housing (2).

To the contrary, the obstacle body (7″) is partially connected with the housing (2) at its outer circumference. The obstacle body (7″) however has several approximately radially extending flow-through gaps (6′), which can expand radially from the inside to the outside. The approximately radially extending separation edges (8) can be straight and extend exactly in a radial manner, or they can be serrated (separation edge (8′)) or undulated (separation edge (8″)).

In order to reinforce cavitation, the flow-through gaps (6′) of the single obstacle bodies located behind each other can be offset relative to each other in circumferential direction, as pointed out in the right half of FIG. 5.

The surfaces (F₆) of the flow-through gaps (6) can change in flow direction (10) from one obstacle body to the next in a predetermined manner, e.g. they can decrease, wherein e.g. the opening angles of the segment shaped flow-through gaps (6) become smaller and smaller and/or through the reduction of the interior diameter of the flow-through chamber, this means of the housing (2).

### DESIGNATIONS

1 Mixer
1′ Stabilizer
2 Housing
3a,b Intake opening
4 Outlet opening
5 Flow-through chamber
6,6′ Flow though gap
7,7′ Obstacle body
8 Separation edge
9 Impact plate
9a Impact surface
10 Main flow direction
11 Flow direction 1^{st} component
12 Flow direction 2^{nd} component
13 Cross section contraction
14 Cross section expansion
15 Central axis
16 Conduit
17 Constant diameter section
18 Bottleneck
19 Conduit
20 Mixture
21 1st. component
22 2nd. component
23, 23′ Conduit elbow
24 Cut off valve
25 Support
26 Counter nut
F Surface
F₆ Surface of (6)
v Flow velocity
v(7a) Flow velocity past the obstacle body (7a) in the flow-through gap

Although several embodiments of the present invention and its advantages have been described in detail, it should be understood that changes, substitutions, transformations, modifications, variations, permutations, and alterations may be made therein without departing from the teachings of the present invention or the spirit and scope of the invention being set forth by the appended claims.

1. A mixer for mixing or stabilizer for stabilizing at least two through flowing components, at least one component of the at least two through flowing components being liquid, through a hydrodynamic cavitation field, said mixer comprising:
a housing;
an intake opening that supplies at least one of the at least two through flowing components;
an outlet opening for exhausting a mixture;
a flow-through chamber between the intake opening and the outlet opening;
a plurality of plate-shaped obstacle bodies lie in a plane perpendicular to a main flow direction and are located in the flow-through chamber, the plurality of plate-shaped obstacle bodies have sharp separation edges; and
a plurality of flow-through gaps between edges of the plurality of plate shaped obstacle bodies and the housing, the gaps have surface areas that decrease in the main flow direction as measured perpendicular to the main flow direction;
a conical contraction section is located after the intake opening and is subsequently followed in the main flow direction by a conical expansion section in front of the plurality of plate shaped obstacle bodies; and
a first obstacle body of the plurality of plate shaped obstacle bodies is an impact plate.

2. A mixer or stabilizer according to claim 1 wherein said impact plate is concave on a side facing the main flow direction.

3. A mixer or stabilizer according to claim 1 wherein at least a second intake opening is located in a center of said impact plate and is provided through a central conduit along the main flow direction through the other of said plurality of plate-shaped obstacle bodies.

4. A mixer or stabilizer according to claim 1 wherein a section with constant cross section is located between where the conical contraction occurs and said impact plate.

5. A mixer or stabilizer according to claim 1 wherein said outlet opening exits said housing oriented in main flow direction in a radial manner.

6. A mixer or stabilizer according to claim 1 wherein said plurality of plate-shaped obstacle bodies are axially adjustable.

7. A mixer or stabilizer according to claim 1 wherein said plurality of plate-shaped obstacle bodies are axially adjustable relative to each other and are axially adjustable relative to a central axis.

8. A mixer or stabilizer according to claim 1 wherein said plurality of plate-shaped obstacle bodies are sized so as to be able to oscillate in the main flow direction.

9. A mixer or stabilizer according to claim 1 wherein a flow-through gap is located between an exterior perimeter of said plurality of plate-shaped obstacle bodies and said housing surrounding the exterior perimeter.

10. A mixer or stabilizer according to claim 1 wherein said plurality of plate-shaped obstacle bodies are radially connected on an outside with said housing and have open segments for through flow within their circumference.

11. A mixer or stabilizer according to claim 1 wherein said sharp separation edges of the plurality of plate shaped obstacle bodies have an extension as long as possible, and wherein said sharp separation edges are undulated or serrated as seen in either an axial direction or a direction perpendicular to the axial direction.

12. A mixer or stabilizer according to claim 11 wherein an inside contour of said housing surrounding said sharp separation edges has an analogously undulated or serrated contour to said sharp separation edges as seen in the axial direction.

13. A mixer or stabilizer according to claim 1 wherein said conical contraction section after the intake opening is sized such that a flow velocity at the beginning of said conical contraction section is equal to a flow velocity of the mixture at a last of said plurality of plate-shaped obstacle bodies.

14. A mixer or stabilizer according to claim 1 wherein said conical contraction section after the intake opening is sized such that a flow velocity at a bottleneck of the conical contraction section is slightly higher, in particular between 5% and 20% higher than the flow velocity of the mixture at a last of said plurality of plate-shaped obstacle bodies.

15. A mixer or stabilizer according to claim 14 wherein the flow velocity at a bottleneck of said conical contraction section is between 5% and 20% higher than the flow velocity of the mixture at the last of said plurality of plate-shaped obstacle bodies.

16. A mixer or stabilizer according to claim 1 wherein said plurality of plate-shaped obstacle bodies are round discs with a diameter decreasing in the main flow direction and a distance from said housing to each outer edge of each of the discs is the same.

17. A mixer or stabilizer according to claim 1 wherein said plurality of plate-shaped obstacle bodies are discs with constant diameter, and a radial distance from said housing to each outer edge of each of the discs decreases in main flow direction.

18. A mixer or stabilizer according to claim 17 wherein said discs are identical.

19. A mixer or stabilizer according to claim 1 wherein said conical contraction section after the intake opening narrows such that flow velocity increases by a factor of 9 to 13.

20. A mixer or stabilizer according to claim 19 wherein said conical contraction section after said intake opening narrows such that flow velocity increases by a factor of 10 to 12.

21. A mixer or stabilizer according to claim 20 wherein said conical contraction section after said intake opening narrows such that flow velocity increases by a factor of 10.5 to 11.5.

22. A mixer or stabilizer according to claim 1 wherein said plurality of plate-shaped obstacle bodies are positioned and sized relative to each other or said housing such that flow velocity in a flow-through gap of a last of the plurality of plate-shaped obstacle bodies in the main flow direction increases by a factor of 1.8 to 2.5 as compared to the flow velocity in the flow-through gap of the first obstacle body is increased by a factor of 1.8 to 2.5.

23. A mixer or stabilizer according to claim 22 wherein the factor is 2.0 to 2.3.

24. A mixer or stabilizer according to claim 1 wherein said plurality of plate-shaped obstacle bodies are discs are positioned and sized relative to each other and relative to said housing such that flow velocity in a respective flow-through gap from one plate-shaped obstacle body to the next plate-shaped obstacle body in the main flow direction increases by a factor of 1.1 to 1.4.

25. A mixer or stabilizer according to claim 1 wherein there are between 3 and 10 plate-shaped obstacle bodies in said plurality of plate-shaped obstacle bodies.

26. A mixer or stabilizer according to claim 2, wherein there are between 5 and 7 plate-shaped obstacle bodies in said plurality of plate-shaped obstacle bodies.

27. A mixer or stabilizer according to claim 1 wherein an axial thickness of each of said plurality of plate-shaped obstacle bodies is between 1 mm and 4 mm.

28. A mixer or stabilizer according to claim 1 wherein an axial thickness of each of said plurality of plate-shaped obstacle bodies is between 2 mm and 3 mm.

29. A mixer or stabilizer according to claim 1 wherein the axial distance from a middle of one of said plurality of plate-shaped obstacle bodies to a middle to the middle of a neighboring one of said plurality of plate-shaped obstacle bodies is double to seven fold the thickness of the one of said plurality of plate-shaped obstacle bodies.

30. A mixer or stabilizer according to claim 29 wherein the axial distance from the middle of one of said plurality of plate-shaped obstacle bodies to the middle to the middle of a neighboring one of said plurality of plate-shaped obstacle bodies is three to five fold the thickness of the one of said plurality of plate-shaped obstacle bodies.

31. A mixer or stabilizer according to claim 1 wherein a radial width of an annular gap between said plurality of plate-shaped obstacle bodies and said housing is 1 mm to 5 mm.

32. A mixer or stabilizer according to claim 31 wherein the radial width is 1.5 mm to 3.8 mm.

33. A mixer or stabilizer according to claim 1 wherein an axial length of a section with constant cross section between said conical expansion section and said impact plate equals 0.7 to 1.4 times the diameter after said conical expansion section.

34. A mixer or stabilizer according to claim 1, wherein a free internal diameter after said conical expansion section and before the first impact plate equals 0.9 to 1.1 times a free cross section of an inlet or outlet conduit.

35. A mixer or stabilizer according to claim 1 wherein a free cross section after said conical expansion section and before said impact plate has 1.0 to 2.0 times a free diameter of an in inlet or outlet conduit.

36. A mixer or stabilizer according to claim 1 wherein
said plurality of plate-shaped obstacle bodies includes the first plate-shaped obstacle body, a second plate shaped obstacle body and one or more other plate shaped obstacle bodies;
the first plate-shaped obstacle body has a substantially larger axial extension than the one or more other plate shaped obstacle bodies, and
the first plate-shaped obstacle body has an external circumference with an annular concave groove such that the first plate shaped obstacle body has two annular circumferential separation edges.

37. A mixer or stabilizer according to claim 36 wherein
said second plate-shaped obstacle body has a substantially larger axial extension than the one or more other plate shaped obstacle bodies, and
said second plate-shaped obstacle body has an external circumference with an annular concave groove such that the second plate-shaped obstacle body has two annular circumferential separation edges.

38. A mixer or stabilizer according to claim 1 wherein said sharp separation edges have an angle below 60° in cross section.

39. A mixer or stabilizer according to claim 38, wherein said sharp separation edges have an angle below 50° in cross section.

40. A mixer or stabilizer according to claim 39 wherein said sharp separation edges have an angle below 45° in cross section.

41. A mixer or stabilizer according to claim 1 wherein several of said plurality of plate-shaped obstacle bodies are combined into a group and can be moved in axial direction only together along a central axis.

42. A mixer or stabilizer according to claim 1 wherein
the first obstacle body has a first sharp separation edge and a second sharp separation edge, the first sharp separation edge is located before the second sharp separation edge in the main flow direction;
the first sharp separation edge is within a section of the housing with a constant interior diameter; and
the second sharp separation edge is within an axial section of the housing with a contracting interior diameter.

43. A mixer or stabilizer according to claim 1 wherein the mixer is sized so as to generate a pressure drop of 2.5 to 3.0 bars over an entire length of the mixer.

44. A mixer or stabilizer according to claim 1 wherein each of said plurality of plate shaped obstacle bodies with a thickness of less than 3 mm have a straight edge line at its outer perimeter, the straight edge line is parallel to a longitudinal axis or parallel to a wall of the housing.

45. A mixer or stabilizer according to claim 1 further having at least a second intake opening for a second component of the at least two through flowing components, the second component of the at least two through flowing components is added in reverse flow to the main flow direction.

46. A method for mixing or stabilizing at least two through flowing components, at least one component of the at least two through flowing components being liquid, through a hydrodynamic cavitation field, said method comprising the steps of:
providing a housing including an intake opening and an outlet opening;
supplying at least one of the at least two through flowing components through the intake opening;
providing a flow-through chamber between the intake opening and the outlet opening;
providing a plurality of plate-shaped obstacle bodies that lie in a plane perpendicular to a main flow direction and are located in the flow-through chamber, the plurality of plate-shaped obstacle bodies having sharp separation edges and a first obstacle body of the plurality of plate-shaped obstacle bodies being an impact plate;
providing a plurality of flow-through gaps between edges of the plurality of plate-shaped obstacle bodies and the housing, the plurality of flow-through gaps having surface areas that decrease in the main flow direction as measured perpendicular to the main flow direction;
contracting the at least two through flowing components with a conical contraction section located after the intake opening and then subsequently expanding the at least two through flowing components with a conical expansion section in front of the plurality of plate shaped obstacle bodies; and
exhausting a mixture through the outlet opening.

47. A method according to claim 46 further including the step of supplying in reverse flow to the main flow direction a second component of the at least two through flowing components through at least a second intake opening.
